(19) United States
(12) Patent Application Publication
(10) Pub. No.: US 2010/0222967 A1
(43) Pub. Date: Sep. 2, 2010

(54) Multiturn rotational sensor

(75) Inventors: Jeffry Tola, Upland, CA (US); Kenneth A. Brown, Banning, CA (US)

Correspondence Address: KRIEG DEVAULT LLP, ONE INDIANA SQUARE, SUITE 2800, INDIANAPOLIS, IN, 46204-2079, US

(73) Assignee: TT Electronics Technology Limited

(21) Appl. No.: 12/799,830

(22) Filed: May 3, 2010

Related U.S. Application Data
(63) Continuation of application No. PCT/US2007/012354, filed on May 24, 2007.
(60) Provisional application No. 60/808,009, filed on May 24, 2006.

(51) Int. Cl. G06F 19/00; G01M 17/06

(52) U.S. Cl. 701/41; 702/151

(57) ABSTRACT

A rotational sensing system is disclosed that includes a first sensing device including a first portion fixed to a body to rotate therewith in unison and provide a plurality of first device signals, a second sensing device including a second portion mechanically coupled to the body to rotate with a mechanical turn ratio relative to the body and provide a plurality of second device signals, and signal processing circuitry responsive to the first device signals to represent rotation of the first portion relative to the body with a virtual turn ratio different than unity and the mechanical turn ratio. This signal processing circuitry also includes logic operable to provide an output representative of rotational position of the body over an angular range spanning more than 360° as a function of the first device signals and the second device signals based on the virtual turn ratio.

### CROSS-REFERENCE TO RELATED APPLICATIONS

The present application is a continuation of International Patent Application No. PCT/US2007/012354 filed on May 24, 2007, which claims the benefit of U.S. Provisional Patent Application No. 60/808,009 filed on 24 May 2006, both of which are hereby incorporated by reference each in its entirety.

### BACKGROUND

The invention relates to a technique to determine absolute position of a rotatable body, and more particularly, but not exclusively relates to methods, devices, apparatus, and systems to determine position of a rotatable body that turns at least 360 degrees relative to a predetermined reference position, including but not limited to a vehicle steering wheel.

A requirement of many electronically controlled mechanical systems is the accurate detection of the angular position of a control input device, such as a rotating shaft. Often, mechanically optimized systems provide control functionality with fine resolution and improved performance through the use of gearing arrangements that enable multiple 360 degree revolutions of an input control shaft over the full range of system control. One such system is found in vehicle steering control systems, where it is common to utilize four full revolutions of the steering shaft in normal operation (1440 degrees of rotation).

It is a common requirement of steering control systems using a shaft angle input, that the detection method and apparatus provide the total number of full revolutions of the shaft relative to a known reference position, and an accurate measurement of shaft position within the absolute referenced 360 degree range of the present revolution. These accurate, multiple turn measurements are typically, required to be performed in a limited mechanical space with minimum moving components.

A common arrangement used for detecting the required multiple turn absolute position is described in references, including U.S. Pat. Nos. 5,930,905; 6,861,837B1; 6,466,889B1; 6,862,551B1; and 6,941,241B2 among others. All these methods and devices use a primary mechanical spur gear attached directly to the rotating body to turn therewith, and at least two additional rotating bodies actuated by smaller secondary spur gears engaged with the primary gear and rotating at a known ratio to the primary as depicted in FIG. 1. Typically these two secondary gears are rotating at a significantly higher rate than the primary gear. These secondary gears are coupled to sensing devices that are used to determine the position of each secondary gear, relative to the primary gear fixed to the rotating body of interest. A predetermined gear ratio difference between the two secondary gears is applied to generate sensor signals with a relative output relationship that varies with absolute gear position established by the different effective rotation rates of the secondary gears. This relative relationship is directly proportional to the number of full turns of the primary gear.

These arrangements typically have two additional and separate rotating bodies controlled by secondary gears with gear ratios that are close to one another. In the limited mechanical space available for packaging the usual detection device, the selection of two secondary gears that are significantly smaller than the primary gear and differ from each other by one gear tooth count has become common. These two external, secondary gears require close mechanical tolerance to ensure that the detected signals perform as desired based on the predetermined mathematical relationship, and generally are not tolerant to mechanical anomalies resulting from normal manufacturing tolerances and/or mechanical wear.

Furthermore, the use of multiple gears, not only increases size, complexity and cost of the detection system, but also increases the likelihood that mechanical tolerances of the as-built and/or aged/worn components will negatively influence system performance—including accuracy and stability.

Thus, there is a demand for ongoing contributions in this area of technology.

### SUMMARY

In one embodiment, the present application provides a unique technique for sensing rotational position. In other embodiments, a unique system, apparatus, device, and/or method is provided that involves the detection of rotational position information of a body that turns at least 360 degrees.

Further embodiments include a method and device for providing multiturn absolute angular position information with reduced complexity and improved reliability by using a detector directly coupled to the primary rotating body whose absolute position is required and only one additional rotating body, eliminating the need for two secondary rotating bodies mechanically geared to rotate in association with the primary rotating body of interest.

In still further embodiment, a compact rotation angle detector is provided in which a detection unit, coupled directly to the rotating body or primary measurement shaft, is combined with a detection unit monitoring at least one rotating body mechanically coupled and rotating in association with the primary rotating shaft. Both detection units provide similar periodic signals with slightly different periodicities. The periodic signals are combined to produce absolute position information, including measurements representing multiple 360 degree revolutions of the primary shaft (i.e. >360 degrees).

Other embodiments, forms, objects, features, advantages, aspects, and benefits shall become apparent from the following description and drawings.

### BRIEF DESCRIPTION OF THE FIGURES

FIG. 1 is diagrammatic view of a prior art sensor based on three rotating bodies.

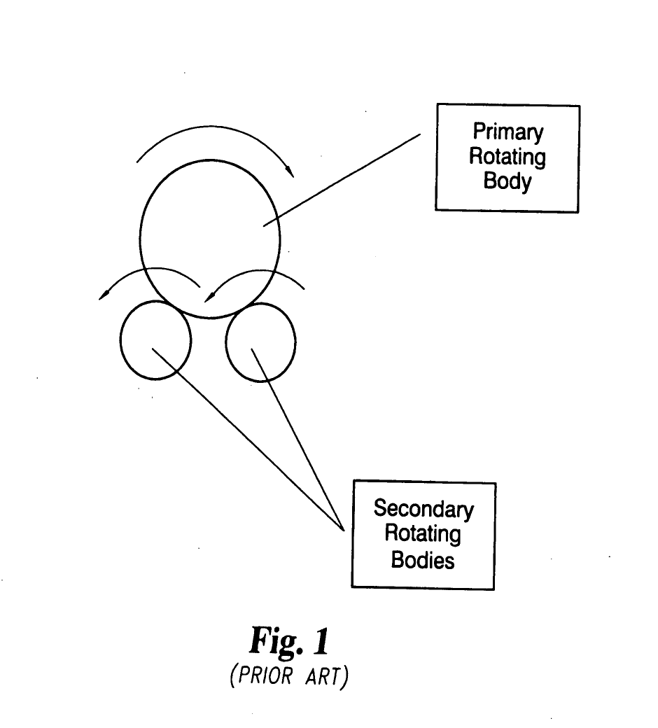

FIG. 2 is a diagrammatic view of a sensor system based on two rotating bodies.

FIG. 3 is a comparative graph of rotation in degrees of the target rotating shaft versus primary and secondary sensing device outputs in degrees.

FIG. 4 is a graph of the rotation in degrees of the target rotating shaft versus a difference signal for the primary and secondary outputs of FIG. 3 in degrees.

FIG. 5 is a graph of the rotation in degrees of the target rotating shaft versus the difference signal of FIG. 4 in degrees with correction.

FIG. 6 is a graph of the rotation in degrees of the target rotating shaft versus the corrected difference signal of FIG. 5 in degrees with scaling.

FIG. 7 is a schematic diagram of a signal processing system including the primary and secondary sensing devices of FIG. 4.

FIG. 8 is a comparative signal diagram for the system of FIG. 7.

FIG. 9 is another comparative signal diagram for the system of FIG. 7.

FIG. 10 is a partial diagrammatic view of the electrode patterns for the sensing devices of the system shown in FIG. 7 with corresponding pickups shown in phantom.

FIG. 11 is a partial diagrammatic view of mechanical gearing for the sensing devices of the system shown in FIG. 7 with the corresponding pick-ups shown in phantom.

FIG. 12 is a partial diagrammatic view of a pickup for one of the sensing devices of FIG. 11.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

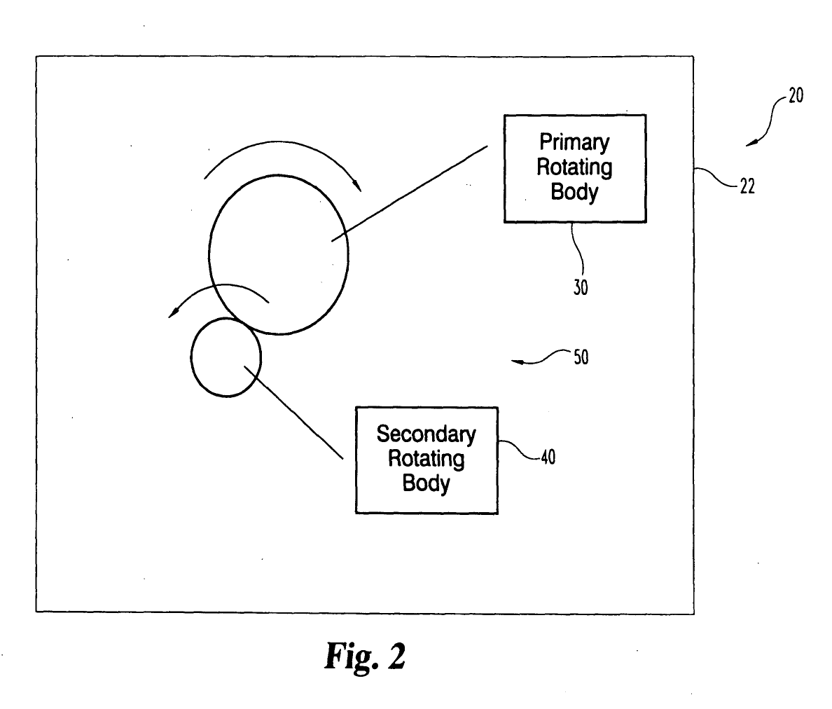

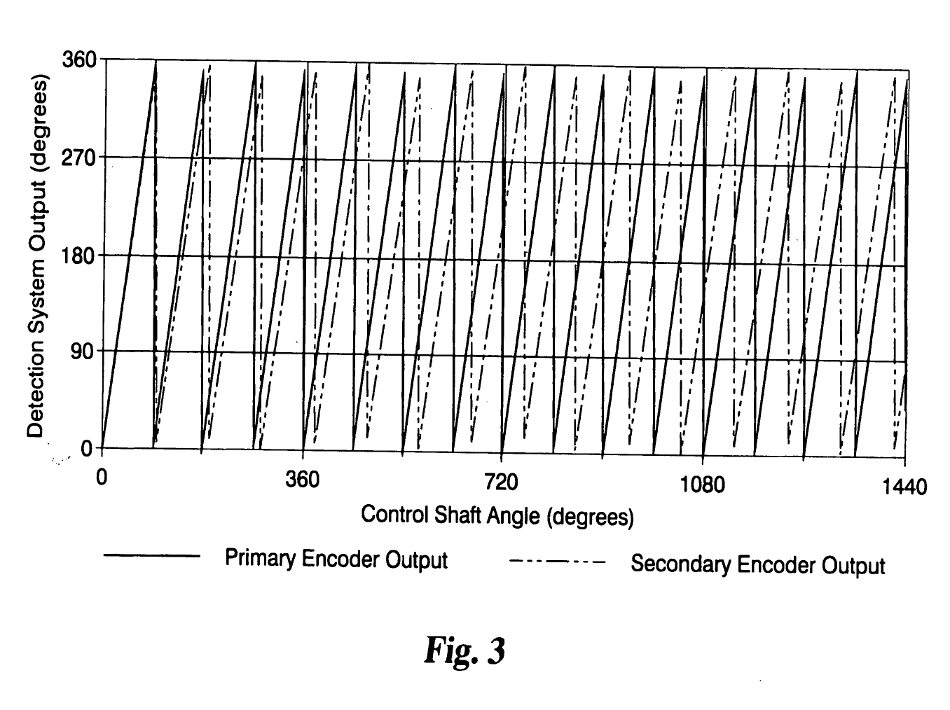

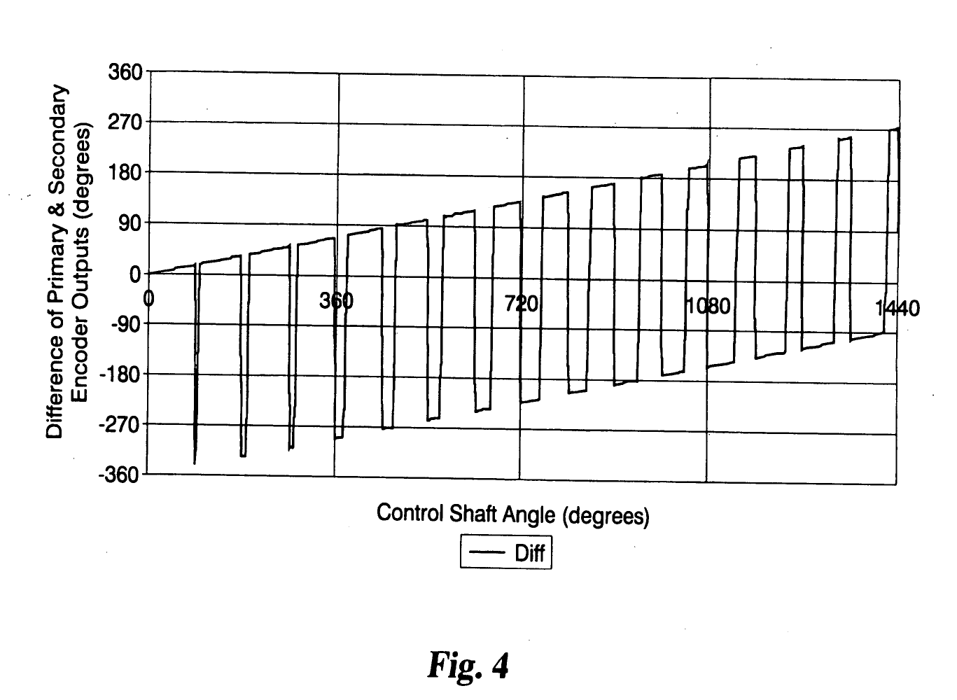

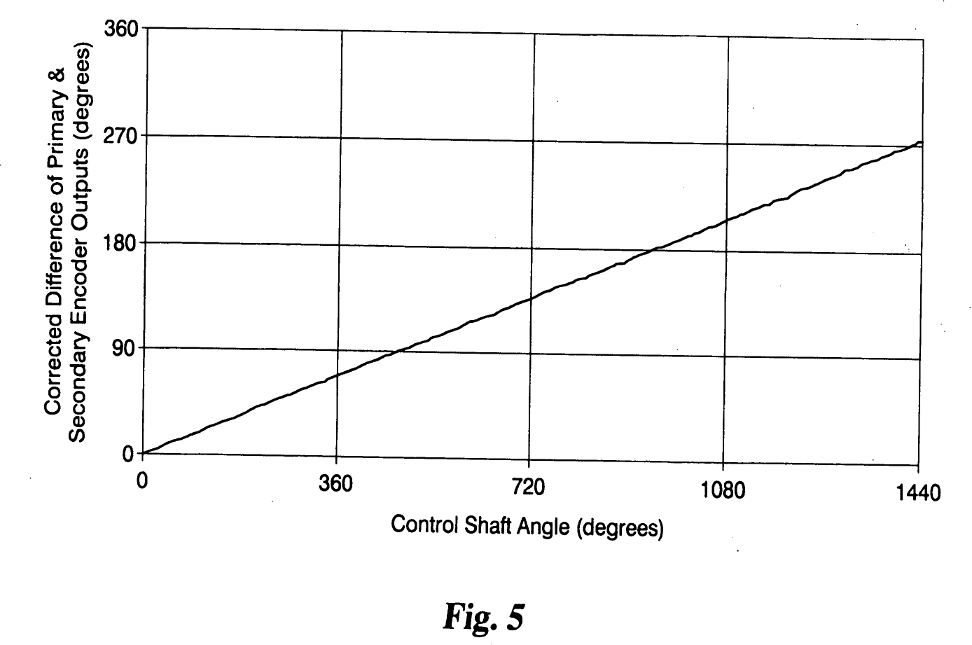

One embodiment of the present invention will be described in association with a high resolution capacitive encoder angular detection method. In one embodiment, a detection device is coupled directly to the control shaft to be measured. This detection device is constructed such that the electrical output of the device is virtually geared to provide a predetermined periodic output with gradually increasing waveforms; like a sawtooth with an effective output pattern equivalent to a mechanical system physically geared to produce a gear ratio greater than unity (>1). The electrical period or virtual gearing of this primary device output is selected to correspond with the mechanical period or gearing of a second detection system coupled to the primary shaft and rotating in association with the primary shaft (see FIG. 2). The mechanical gearing of the second detection system is constructed such that the mechanical gear ratio of the secondary rotating body is slightly lower than the effective electrical gear ratio of the primary detector—for example, a primary virtual electrical gear ratio=4:1 and a secondary mechanical gear ratio=3.8:1—effectively producing an electrically slower moving smaller secondary gear (See FIG. 3). Using a computational control system; such as a microcontroller, the two position signals (primary virtual geared and secondary mechanical geared) are combined to extract and exploit a varying angular phase difference between the two signals resulting from the different effective rates of rotation (See FIG. 4). This difference signal can be scaled and logically manipulated to produce a continuous linearly increasing or decreasing signal (slope polarity determined by direction of rotation) with unique values for the entire range of the design system; including movements of greater than 360 degrees (See FIGS. 4 and 5).

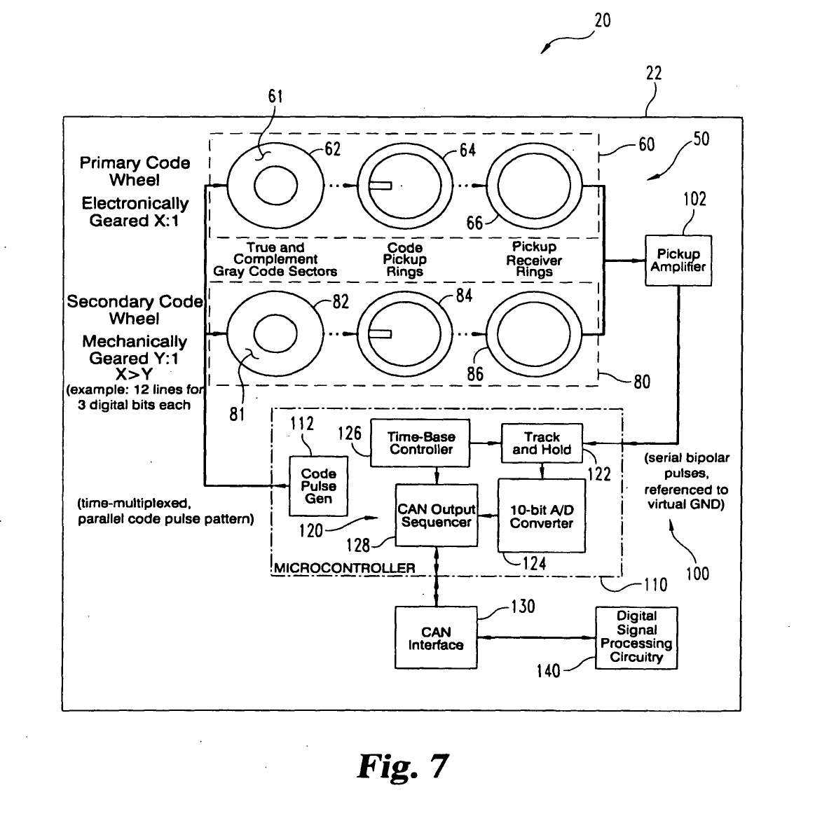

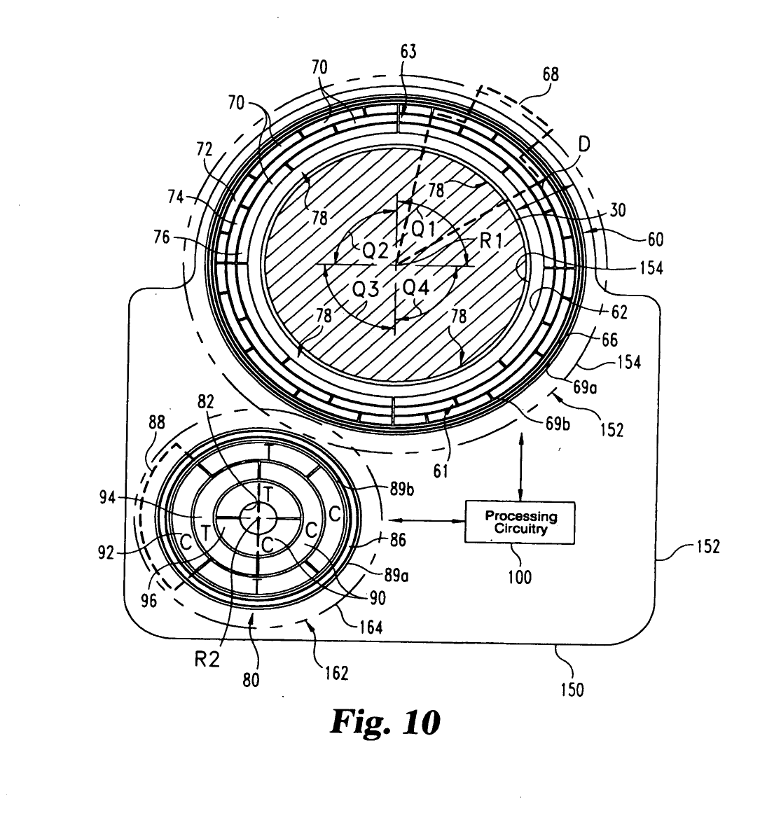

In the case of a capacitive encoder detection device, as described in FIG. 7, a coaxial annular code pattern representing a binary equivalent of 0 to 360 degrees of rotation can be compressed to the appropriate angular span and repeated around the circumference of the primary measurement shaft such that an effective electrical gearing of >1 is achieved. In a capacitive encoder, this pattern is constructed using traditional printed circuit board patterning technology, and typically contains a series of coaxial annular line segments centered about an axis representing the point of rotation of the rotating body. The patterned substrate is fixed and stationary relative to the rotating shaft. These coaxial annular patterns or “tracks” are repeated in a radial progression based on the binary resolution desired in the measurement system. The number and length of the annular line segments making up each coaxial element or track is determined by the code system used; typically Gray code, and the bit position represented by the track. Commonly owned U.S. Pat. Nos. 7,119,718; 7,123,027; and 7,138,807 provide further description regarding various capacitance-based rotational sensing techniques, methods, devices, and systems that can be used to implement various aspects of the present application; and are hereby each incorporated by reference in its entirety. In the example of FIG. 7, a 3 bit Gray code encoder contains 3 coaxial annular tracks; representing the Most Significant Bit (MSB), the MSB−1, and the Least Significant Bit (LSB), respectively. The Gray code sequence produces two 180 degree annular ring segments for the MSB and MSB−1 bit tracks, and four 90 degree annular ring segments for the LSB track. FIG. 10 further illustrates this tract pattern as described in greater detail below.

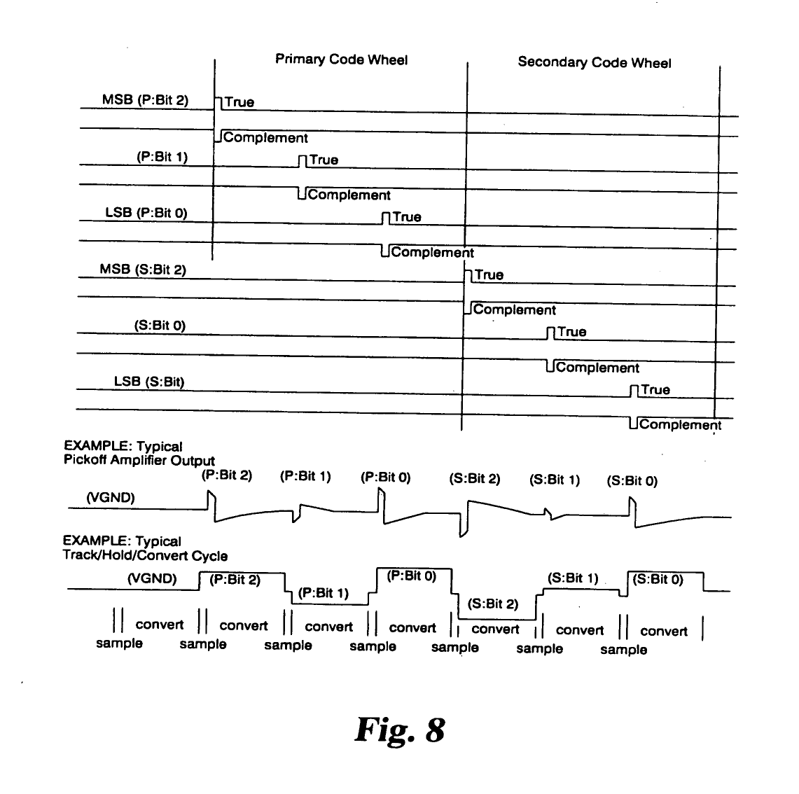

In a capacitive encoder based system, the code pattern is electrically interrogated by sequentially providing a series of simultaneous pulse pairs of opposite polarity to each code track. Within each track pulse event, opposite polarity signals are simultaneously applied to adjacent segments within a bit track in an alternating or interleaved pattern. A metallic pickup element which is generally rectangular in shape with an equivalent width approximately equal to the LSB annular span and a length equal to the radial distance covered by the code tracks, is positioned at a fixed axial distance from the code pattern. The pick up is positioned such that its long dimension lies on a ray projecting from the axis of the rotating measurement body and spans the entire radial distance covered by the coaxial bit tracks. The pickup is mechanically coupled to the rotating body of interest such that its angular position relative to the stationary encoder pattern moves in association with the rotating body. Capacitive coupling transmits the series of pulses from the encoder pattern to the pickup. The pickup is electrically connected to another metal pattern which in conjunction with a matching pattern on the encoder substrate, uses capacitive coupling to return the pulse to a stationary control system, such as microcontroller. The polarity, amplitude and sequence of the returned pulses are unique representations of the pickup's rotational position relative to the stationary encoder pattern. The stationary control system coordinates the delivery and reception of the interrogation pulses to decode the pickup position, which represents the measurement shaft position (See FIG. 8).

A 3 bit encoder pattern used by a pickup directly coupled to the measurement shaft provides 8 unique output states occurring at fixed rotation intervals. If the pattern is designed to represent 360 degrees of rotation (one full revolution of the pickup element); this pattern provides 45 degrees of native digital resolution. The segments of the LSB track have an annular span equal to twice the encoder resolution; 90 degrees in this example. If the 3 bit pattern was annularly compressed such that the 8 unique transitions occurred at regular intervals over a span of only 90 degrees, the effective encoder resolution is improved to provide interval detection of 11.25 degrees. Repeating this 90 degree segment pattern 4 times around the circumference of the measurement shaft will produce a periodic 3 bit signal that will produce 4 full range binary sequences (0 through 7) for each complete 360 degree revolution, thus producing an effective electrical gearing of 4:1 without the use of any mechanical gear components or technology. FIG. 10 illustrates this repeated track pattern for sensing device 60, as further described below.

This effective virtual gearing of the detection system can be achieved in other sensing technologies in an equivalent manipulation of the encoding technology; such as optical encoder disks attached to the rotating body or conductive ink patterns interrogated by rotating wipers. An equivalent electrical gearing can be achieved in magnetic sensing technology through the use of a magnet directly coupled to the measurement shaft (1:1 mechanical gear ratio), and the creation of periodic magnetic pole patterns such that a periodic magnetic field is generated and detected by a magnetic field detector, such as a multi-pole ring magnet around the primary measurement shaft producing a sinusoidal varying magnetic field measured by an MR (magnetoresistive) or Hall effect sensor.

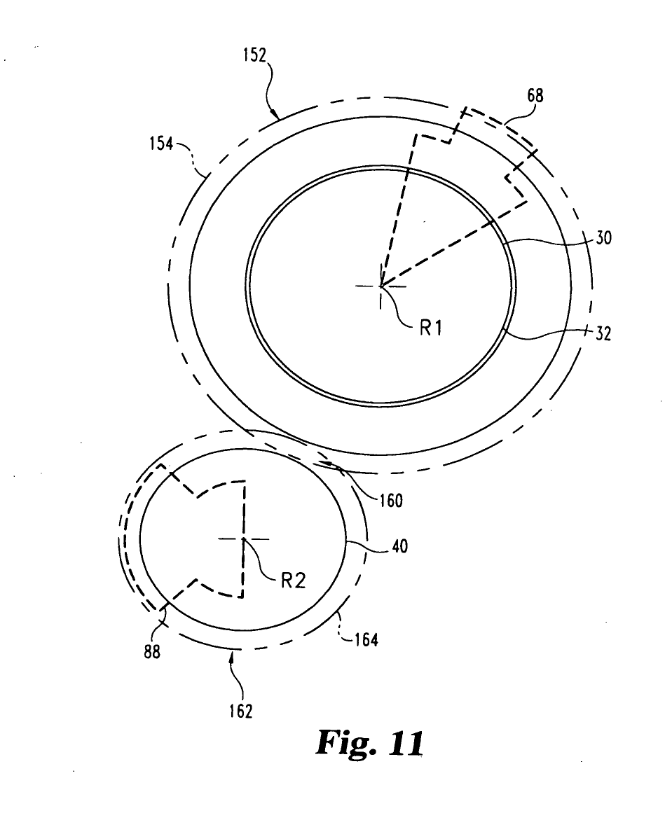

Extending the capacitive encoder to a secondary rotating body is achieved by using two mechanical gears. A spur gear is directly coupled to the measurement shaft with a gear ratio of 1:1, which is achieved in a steering system by inserting the steering shaft into a hole centered inside the gear circumference. A second gear is engaged with the primary, shaft mounted gear to move in association with the primary gear. In one configuration this secondary gear is smaller in diameter than the primary gear, to minimize overall package size. The diameter and gear configuration is selected such that the effective mechanical gear ratio of the secondary rotating body to the primary rotating body is slightly less than the virtual electrical gearing established on the primary capacitive encoder. In the example sighted, the electrical gear ratio of the primary gear is 4:1 and the secondary mechanical gearing is approximately 3.8:1. The secondary detector system encoder pattern is not compressed electrically and represents one full scale cycle for each 360 mechanical degrees of revolution. The resolution of the second encoder pattern is equivalent to the primary pattern and contains the same number of code tracks. The secondary rotating body is attached to the encoder pickup, like the primary system, and therefore the pickup will make multiple 360 mechanical rotations around the encoder pattern for each single 360 degree mechanical rotation of the primary shaft. FIGS. 10 and 11 provide an illustration of a secondary sensing device 80 structured in this way, as further described below.

It is practical to include both encoder patterns on a single printed circuit board, fixing their relative position in the original circuit board photolithography tooling with high precision and superior repeatability in manufacturing, with minimized influence from mating assembly components, processes, or long term aging (see FIG. 10). Again, extension to a magnetic based solution is easily implemented with a single magnet attached to the secondary rotating body. The magnetic pattern imprinted on this magnet would be appropriately configured to produce a reduced number of full scale excursions per revolution determined by the periodicity implemented in the primary magnet.

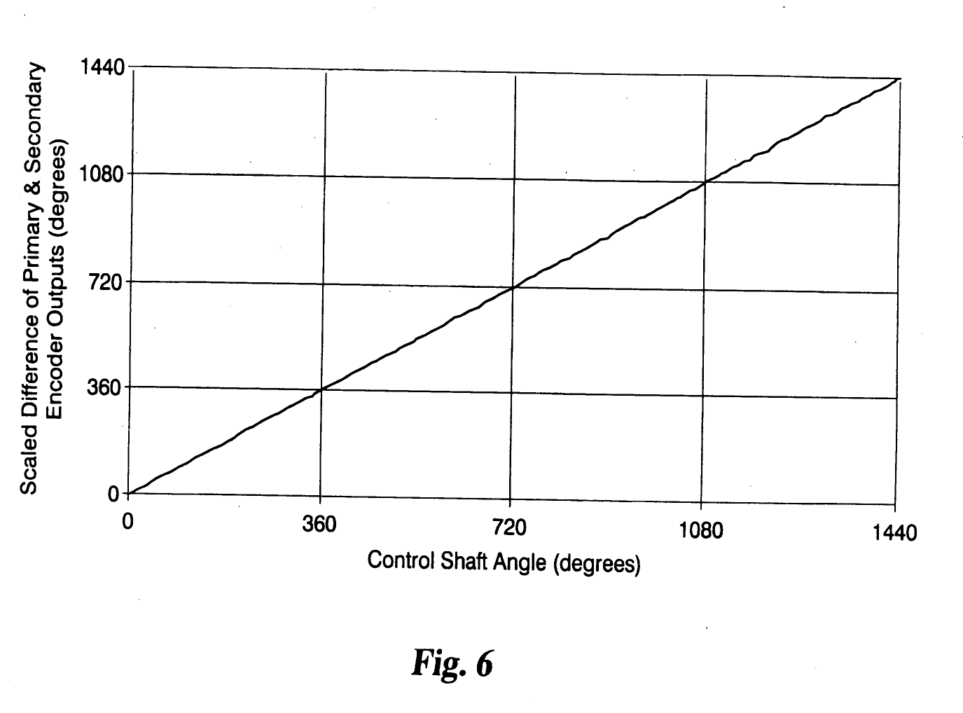

The microcontroller based control system decodes and normalizes the position information from the primary detector and the secondary detector to represent two signals which are offset by an increasing value proportional to the position difference generated by the effective gear difference between the primary and secondary systems. It has been found this difference is a linearly increasing function (see FIGS. 4 and 5). The slope of this difference function is proportional to the combination of mechanical and electrical gearing achieved in the actual sensor and is easily scaled after characterization of the function in the actual sensor produced (see FIG. 6). A simple constant multiplier is applied to the difference value. It has been found a relatively wide range of effective scale factors can be derived to accommodate normal variations in mechanical gear systems, thus producing a robust system for manufacture. The difference function does contain occasional discontinuous polarity changes. These polarity discontinuities are easily corrected with the addition of a correction constant. Typically the addition of 360 degrees will accurately remove this discontinuity (compare FIG. 4 and FIG. 5).

This configuration provides a detection system with a full scale measurement range greater than 360 rotational degrees. In the capacitive encoder implementation and any other digital based technology such as, photo-interrupter based optical encoders or multi-pole magnetic encoders, the detection device resolution and in turn the accuracy, are determined by the native digital resolution of the primary and secondary encoders along with the effective gear ratios. Native digital resolution of all digital encoded position detection systems is limited by the installation area available, the sensitivity of the detection method, and the manufacturing capabilities of the encoder pattern process. It is generally accepted that higher resolution digital position detection requires larger patterns for improved signal to noise performance and robust manufacturing. Through the use of the combined electrical and mechanical gearing and signal processing, the rotational resolution is improved beyond the native resolution of each encoder. In the example provided (4:1 electrical gearing of the primary encoder), the native resolution is increased from the native 3 bits to 5 bits due to the amplification of the encoder sensitivity.

In the case of the steering wheel sensor, installation area is limited, and enhanced resolution through increased native digital resolution of the primary encoder pattern is not desirable; as it will either increase the diameter of the primary encoder due to added code tracks/bits, or challenge traditional printed circuit board manufacturing capabilities by the addition of added code tracks/bits within a limited radial space. Additionally, reduction of code track geometries for increased density will negatively impact signal to noise ratios for all sensing technologies, and a limit in signal detection may be reached, before manufacturing limits prevail.

In the capacitive encoder configuration described, detection resolution can be enhanced through the addition of additional processing of the analog signal pulses used to determine the discrete binary position of the pickup relative to the encoder pattern. The basic system operation interprets the polarity of the received signal as indicative of a pickup position of a logical “1” or “0”, over a track segment defined by the resolution of that track. So, in the case of the 3 bit pattern described here, a “1” or “0” detected on the LSB track indicates a pickup position within one of four 90 degree segments that comprise that track. When combined with the other bits, location can be determined to within a known absolute 45 degree segment. As mentioned, in addition to the polarity information, which is easily discriminated as a binary state, the amplitude of the received pulse is representative of the relative pickup position within the track segment and can be processed to interpolate an exact position within the LSB resolution range that can be added to the native digital positional information, thus providing greater resolution. In practical circumstances, the resolution is limited by the analog measurement capability included in the detection control system, which is typically dependent on analog to digital converters included in the microcontroller.

As is the case with the binary implementation of encoder techniques, the analog interpolation method is also impacted by size of the encoder track elements. The finest resolution is attained by using the analog signal values generated by the LSB element. In using the LSB segments, the analog measurement resolution of the microcontroller is applied over the smallest relative position span. However, the LSB elements having the smallest angular span and in turn the smallest physical size, also produce the lowest signal to noise performance. Additionally the small size of the LSB produces non-ideal signal interactions that generally degrade the linear relationship between the received voltage amplitude and the pickup position. These non-ideal responses can be accommodated in a microcontroller through a look-up table, or other mathematical operations. However, in many applications where the native digital resolution is as high as 7 or 8 bits, the errors generated by non-linear behavior are not significant when compared with the additional 4 or 5 bits of resolution being derived from the LSB detection range, and a simple linear relationship can be assumed.

In some steering wheel applications, limited installation space practically limits a primary capacitance-based encoder to a resolution of 3 or 4 bits. As described, the 3 bit native encoder when combined with the gearing mechanisms will produce a native 5 bit resolution or 11.25 degrees. In contrast, in some applications a resolution of 12 bits is generally sought for steering control systems. To achieve this higher resolution an additional 7 bits of information is desired from interpolation of analog signals. Such a high discrimination objective is often negatively impacted by both the small geometries of the compactly configured encoder pattern, and the non-linear characteristics of the analog signals relative to the angular pickup position.

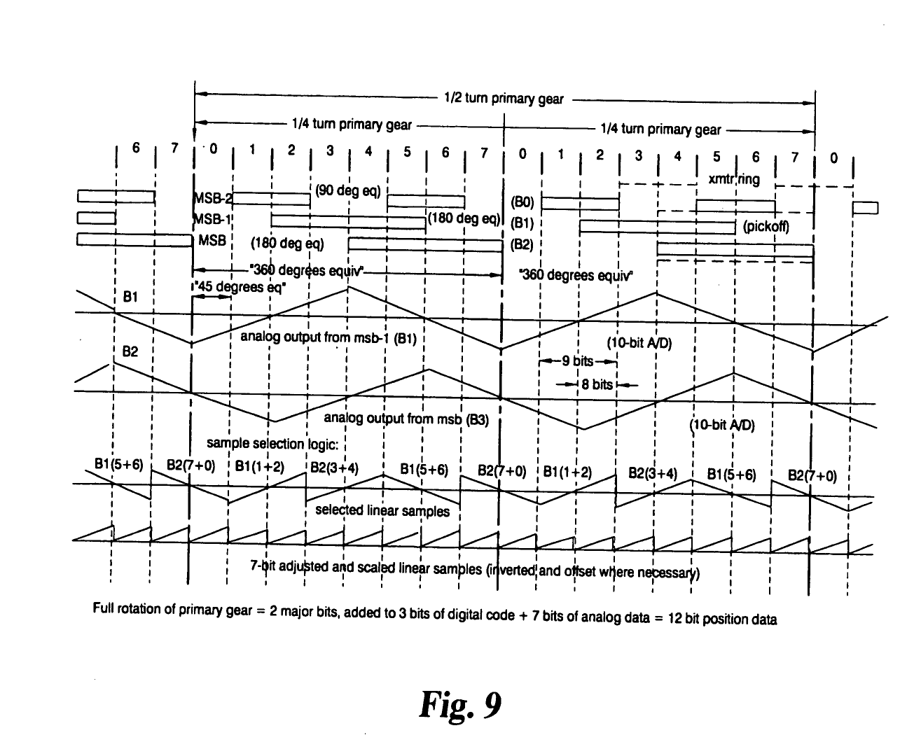

To improve analog interpolation performance in conjunction with minimum native digital encoder pattern resolution, a unique encoder pattern is exploited that allows use of more robust pattern elements while discriminating non-linear portions of the analog response and substituting alternate equivalent signals with improved linear characteristics. The new encoder pattern potentially includes the addition of one code track; however, this addition may not always be necessary as further explained below. For this refinement, the potentially added code track has identical annular code segment geometries to one of the previously described native encoder code tracks, but is angularly rotated relative to the original native encoder track by one half of the angular span of elements that comprise the selected track. In the example presented here, the LSB+1 track was chosen as the interpolation track. In the 3 bit example, the Bit 1 (LSB+1) track with 180 degree annular segments is duplicated in an additional track that is angularly rotated 90 degrees relative to the original track and is represented a Bit 1S. The analog signals used for the interpolation calculations are now based on the Bit 1 size which is twice that of the LSB; resulting in directly proportional improvement in the signal to noise performance of the raw signal measurement. It has been identified that the most significant non-linear behavior in the analog signal occurs near the peak levels of the periodic signal, which occurs as the pickup approaches and passes the center of the code segment. The portions representing the transition between polarities that occurs as the pickup approaches and passes adjacent segments are typically nearly linear. By rotationally offsetting the two identical tracks, a linear portion is always available for interpolation from either track. The selection of which track to use is accomplished by a truth table based on the logical values of the pickup encoder position represented by the interpolation bit (Bit 1), the shifted interpolation bit (Bit 1S), and the next lower order bit (in this example, Bit 0 or the LSB). Within standard microcontrollers it is common to find 10 bit analog to digital converters. In the 3 bit example described here, a 7 bit value is required to be derived from the original 10 bit received analog signals. Reliable extraction of the required resolution is easily achieved. See FIG. 9.

A unique consequence of using this method with a 3 bit Gray code is that the MSB is already equivalent to the MSB+1 and offset by one half the angular distance of the code segment. In this particular case, an additional 1S ring of the more general case described above is not required, and the MSB ring values can be used. Using the two encoder patterns and the described interpolation method, a high resolution angle detection system can be produced with minimum mechanical components and reduced electronic complexity. In the example sighted, a detection system with 12 bit resolution can be achieved with the electrical interrogation of two 3 bit encoders, thus representing a highly desirable result from two relatively simple and coarse detector systems.

Next, further detailed embodiments are described indicating various aspects and features illustrated in the figures with reference numerals. FIG. 2 diagrammatically illustrates system 20 including vehicle 22 that has a primary rotating body 30 and a secondary rotating body 40 that collectively provide a multiturn rotational position sensing system 50. Each of bodies 30 and 40 rotate in response to rotation of the other. Referring additionally to FIG. 11, primary rotating body 30 is further shown in the form of a steering shaft 32 for a steering mechanism of vehicle 22. Fixed to steering shaft 32 to turn therewith is a spur gear 152 disposed about the circumference of shaft 32, such that shaft 32 extends therethrough. Spur gear 32 includes circumferential radial teeth 154. A common rotational axis R1 of body 30, shaft 32, and gear 152 is designated by crosshairs to represent that rotational axis R1 is perpendicular to the view plane of FIG. 11. Secondary rotating body 40 is further shown in the form of spur gear 162 with circumferential radial teeth 164. Gear 162 is mechanically coupled to turn with gear 152 via gear mesh 160 formed with teeth 154 and 164. Gear 162 has rotational axis R2 as designated by crosshairs to represent that it is also perpendicular to the view plane of FIG. 11.

Referring also to FIGS. 7 and 10, system 50 includes rotational position sensing device 60 and rotational position sensing device 80. Signal processing circuitry 100 is operatively coupled to devices 60 and 80 as further described hereinafter. Sensing device 60 includes a face 61 defining a generally concentric electrode track pattern 62 of sensing tracks 63—specifically, three tracks as previously described. Tracks 63 are comprised of alternating TRUE (T) and COMPLEMENT (C) electrically conductive, arcuate electrode segments 70 provided in a binary Gray code format (only a few are labeled by reference numerals and the T and C designations are not shown to preserve clarity). An outer electrically conductive pickup receiver ring 66 on face 61 circumscribes tracks 63. Ring 66 is disposed between electrically grounded guard rings 69a and 69b on face 61. Tracks 63 are provided in track pattern 78 that is repeated four times—once for each quadrant sector Q1, Q2, Q3, and Q4 to electrically provide a virtual turn ratio of 4:1 with respect to body 30 and shaft 32, even though the mechanical turn ration is 1:1 (unity), which is further described hereinafter.

Opposite tracks 63 is pickup 68 shown in phantom in FIGS. 10 and 11 to extend thereacross. Pickup 68 has an electric conductor shaped consistent with that outlined in phantom in FIGS. 10 and 11 that is positioned opposite face 61 with an air gap therebetween. This shape corresponds to the arc span of each segment 70 of the outermost LSB track 72 and the arc span of innermost MSB track 76 and the middle track 74 (LSB+1=MSB−1). An electrically conductive code pickup ring 64 is labeled schematically in FIG. 7 and not shown in FIGS. 10 and 11. Pickup ring 64 is in electrical continuity with the electric conductor of pickup 68 and is positioned opposite ring 66, overlapping it with an air gap therebetween. Pickup 68 is fixed to shaft 32 and gear 152 to turn therewith in unison about rotational axis R1.

Sensing device 80 includes a face 81 defining a generally concentric, electrode track pattern 82 of sensing tracks 83. Tracks 83 are comprised of alternating TRUE (T) and COMPLEMENT (C) electrically conductive, arcuate electrode segments 90 provided in a binary gray code format as previously described (only a few are labeled by reference numerals to preserve clarity). Tracks 83 are correspondingly labeled with T and C designators while refraining from like labeling of tracks 63 to preserve clarity. An outer electrically conductive pickup receiver ring 86 on face 81 circumscribes tracks 83. Ring 86 is disposed between electrically grounded guard rings 89a and 89b on face 81. The pattern of tracks 83 does not repeat as described in connection with compressed track patterns 78 of face 61.

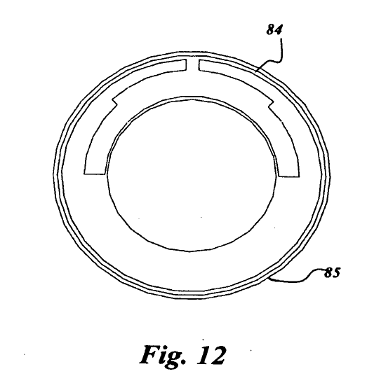

Opposite tracks 83 is pickup 88 shown in phantom in FIGS. 10 and 11 to extend thereacross. Pickup 88 has an electric conductor shaped consistent with that outlined in phantom in FIGS. 10 and 11 that is positioned opposite face 81 with an air gap therebetween. This shape corresponds to the arc span of each segment 90 of the outermost LSB track 92 and the arc span of innermost MSB track 96 and the middle track 94 (LSB+1=MSB−1). An electrically conductive code pickup ring 84 is labeled schematically in FIG. 9 and is also shown in FIG. 12. Pickup ring 84 is in electrical continuity with the electric conductor of pickup 88 and is positioned opposite ring 86, overlapping it with an air gap therebetween. FIG. 12 depicts one nonlimiting example of a pattern for pickup 88 to position opposite face 81. Pickup 88 and ring 84 are provided as a continuous electrically conductive pattern carried on an annular substrate 85 that in one form could be prepared as a printed wiring board using standard photolithographic techniques. Pickup 68 and ring 64 could be prepared in a like manner (no shown); however, in other embodiments such features can be provided in different forms, configurations, structures, and/or arrangements. Pickup 88 is fixed to gear 162 to turn therewith in unison about rotational axis R2.

As shown in FIG. 10, substrate 150 defines faces 61 and 81 of devices 60 and 80, respectively and further carries circuitry 100. In the nonlimiting form depicted, substrate is provided as a printed wiring board 152 that defines aperture 154 through which shaft 32 extends. Board 152 can be prepared using standard photolithographic techniques.

As depicted in FIG. 7, processing circuitry 100 includes an analog pickup amplifier 102, microcontroller 110, computer network interface 120 in the nonlimiting form of a Controller Area Network (CAN) bus interface, and digital signal processing circuit 140. It should be appreciated that some or all of circuitry 100 may not be carried with substrate 150 in other embodiments. Pickup amplifier that receives signals from pickups 68 and 88 of sensing devices 60 and 80 and sends corresponding amplified signals to microcontroller 110. Amplifier 102 may include multiple channels to accommodate both pickup signals simultaneously and/or may be time-shared between the different pickup signals in accordance with timing sequences used to interrogate devices 60 and 80. Microcontroller 110 includes operating logic 120 and various circuits to perform in the manner described hereinafter. Logic 120 may be defined by software programming, firmware programming, hardware, or a combination of these. Likewise, signal processing circuitry 140 may function in accordance with corresponding operating logic of a software, firmware, and/or hardware form (not shown). Microcontroller 110 includes track and hold circuit 122 that holds received input signals from amplifier 102 and provides an ability to sustain the input value for a desired length of time as regulated by time-base controller circuit 126 so that Analog-to-Digital (A/D) converter 124 can convert the analog input signal level into a representative digital form. Microcontroller 110 includes a network output signal sequencer 128 to transmit digital data from A/D converter 124 in accordance with a predefined protocol.

Microprocessor 110 also includes code pulse generator (gen) 112 that provides a predefined sequence of pulses to tracks 63 and 73 in accordance with the T/C (TRUE/COMPLIMENT) gray code designations for each segment 70 and 90, respectively. During operation, it should be appreciated that pickup 68 rotates with shaft 32 about rotational axis R1 and through mesh 160 of gears 152 and 162, pickup 88 turns in response about rotational axis R2. Accordingly, pickups 68 and 88 move over tracks 63 and 83, respectively with such rotation.

Sensing devices 60 and 80 are structured as noncontact rotational position encoders based on capacitive detection. By applying a sequence of time-based pulse pairs of opposite polarity from generator 112 to each of tracks 63 and 83 respectively, an electrical interrogation is performed. These opposing pulse pairs are provided simultaneously to adjacent segments 70 and 90 within a given bit track (72, 74, or 76, and 92, 94, or 96) in an alternating/interleaved pattern as previously described herein and further described in commonly owned U.S. Pat. Nos. 7,119,718; 7,123,027; and 7,138,807 (previously incorporated by reference). For system 50, the signal/timing diagram of FIG. 8 illustrates the interrogation sequence.

During the interrogation, pickups 68 and 88 capacitively couple with tracks 63 and 73 to pass corresponding electrical signals to amplifier 102 via capacitively coupling through rings 64 and 66 for device 60 and rings 84 and 86 for device 80. The polarity, amplitude and sequence of the returned pulses from pickups 68 and 88 are unique representations of the rotational position of pickups 68 and 88 relative to the respective track patterns 62 and 82. Circuitry 100 of system 50 coordinates the delivery and reception of the interrogation pulses to decode pickup position for each device 60 and 80, which represents the rotational measurement of the position of shaft 32.

For device 80, pattern 82 provides 45 degrees of native digital resolution. The segments 90 of the LSB track 92 have an annular span equal to twice the encoder resolution; 90 degrees in this example. With the annular compression of the 3 bit pattern in pattern 62 of device 60, such that the 8 unique transitions occurred at regular intervals over a span of only 90 degrees, the effective encoder resolution is improved to provide interval detection of 11.25 degrees. With the repetition of the resulting pattern 78 four times around the circumference of the measurement shaft 32 as shown in FIG. 10, a periodic three-bit signal results to produce four full-range binary sequences (0 through 7 base ten) for each complete 360 degree revolution—thus producing an effective electrical gearing or virtual turn ratio of 4:1 without the use of any mechanical gear components or technology.

In one configuration, gear 162 is smaller in diameter than gear 152 to minimize overall package size. The diameter and gear configuration is selected such that the effective mechanical gear ratio of the secondary rotating body 40 to the primary rotating body 30 is slightly less than the virtual electrical gearing established on the primary sensing device 60. In one nonlimiting example, the virtual turn/gear ratio (achieved electronically) for the primary body 30 is 4:1 (even though its mechanical turn ratio is 1:1 or unity), and the secondary mechanical turn/gear ratio is approximately 3.8:1. The secondary sensing device 80 is not compressed electrically and represents one full scale cycle for each 360 mechanical degrees of revolution of gear 162 for the depicted embodiment. Further, for this embodiment with the 3.8:1 mechanical turn ratio of gear 162, pickup 88 makes multiple 360 mechanical rotations around the encoder pattern for each single 360 degree mechanical rotation of shaft 32, gear 152, and pickup 68.

Microcontroller 110 and/or digital signal processing circuitry 140 decodes and normalizes the position information from devices 60 and 80 to represent two rotational position signals which are offset by an increasing value proportional to the position difference generated by the effective turn/gear ratio difference between gears 152 and 162. It has been found this difference is a linearly increasing function (see FIGS. 4 and 5). The difference function may include occasional discontinuous polarity changes that can be corrected with the addition of a correction constant. Typically the addition of 360 degrees will accurately remove this discontinuity (compare FIG. 4 and FIG. 5). The slope of this difference function is proportional to the combination of mechanical and electrical gearing achieved with system 50 and can be scaled after characterization of the function as depicted in FIG. 6. It has been found that a relatively wide range of effective scale factors can be derived to accommodate normal variations in mechanical gear systems.

System 50 provides a full scale measurement range greater than 360 rotational degrees and in fact detects multiple complete turns or revolutions of shaft 32—in particular four such turns can be quantified with system 50. In the system 50 implementation, the use of the combined electrical and mechanical gearing and signal processing improves the rotational resolution beyond the native resolution of each sensing device 60 and 80 alone, such that the resolution is increased from the native 3 bits to 5 bits. As previously described, further resolution improvement can be sought by interpolation of an analog signal that more accurately determines pickup position relative to a given track segment. Specifically, in addition to the polarity information that is discriminated in discrete binary terms, the amplitude of the received pulse is representative of the relative pickup position within the track segment and can be processed to interpolate an exact position within the LSB resolution range to add to the native digital positional information, thus providing greater resolution. The finest resolution is attained by using the analog signal values generated with an LSB track segment (those of tracks 72 and 92); however, the analog measurement resolution is applied over the smallest relative position span for an LSB segment and due to the small size of such segments, there is a tendency to produce the poorest signal to noise performance. In some applications (including some steering mechanism applications), limited installation space practically limits a primary capacitance-based encoder to a resolution of 3 or 4 bits. As described, the 3 bit native encoding of device 60 and 80, when combined with the gearing mechanisms will produce a native 5 bit resolution or 11.25 degrees for system 50. At the same time, these applications may seek a resolution of 12 bits. To achieve this higher resolution, an additional 7 bits of information is desired from interpolation of analog signals.

To improve analog interpolation performance in conjunction with minimum native digital encoder pattern resolution, a unique encoder pattern is exploited that allows use of more robust pattern elements while discriminating nonlinear portions of the analog response and substituting alternate equivalent signals with improved linear characteristics. The new encoder pattern potentially includes the addition of one code track; however, this addition may not always be necessary as further explained below. In this refinement, a code track has identical annular code segment geometries to one of the previously described native encoder code tracks, but is angularly rotated relative to the original native encoder track by one half of the angular span of elements that comprise the selected track. This track may or may not be intrinsic to the native pattern. In the example presented here, the LSB+1 track was chosen as the interpolation track. In the 3-bit example, the Bit 1 (LSB+1) track with 180 degree annular segments is duplicated in an additional track that is angularly rotated 90 degrees relative to the original track and is represented as Bit 1S. The analog signals used for the interpolation calculations are now based on the Bit 1 size which is twice that of the LSB; resulting in directly proportional improvement in the signal to noise performance of the raw signal measurement. It has been identified that the most significant non-linear behavior in the analog signal occurs near the peak levels of the periodic signal, which occurs as the pickup approaches and passes the center of the code segment. The portions representing the transition between polarities that occur as the pickup approaches and passes adjacent segments are typically nearly linear. By rotationally offsetting the two identical tracks, a linear portion is always available for interpolation from either track. The selection of which track to use is accomplished by a truth table based on the logical values of the pickup encoder position represented by the interpolation bit (Bit 1), the shifted interpolation bit (Bit 1S), and the next lower order bit (in this example, Bit 0 or the LSB). In the 3 bit example described here, a 7 bit value is required to be derived from the original 10 bits received for analog signals converted by A/D converter 124. FIG. 9 provides a signal/timing diagram corresponding to this interpolation refinement.

A consequence of using such interpolation with the 3 bit Gray code of system 50 is that the MSB is already equivalent to the MSB+1 and offset by one half the angular distance of the code segment. In this particular case, because the required rings are already intrinsic to the pattern, an additional 1S ring of the more general case described above is not required, and the native tracks can be used without addition. Using the two patterns 62 and 82, and the described interpolation technique, a high resolution angle detection system results, such that system 50 can provide 12 bit resolution output signal resolution with the electrical interrogation of two 3-bit devices.

Many other embodiments of the present application are envisioned. For example, in other embodiments more rotating bodies may be utilized with corresponding sensing devices to provide different sensing resolution. In still other examples, different turn ratios may be provided by mechanical linkage other than meshed gears. In a further example, an optical, magnetic, or a different property other than capacitance and/or a combination of these may be utilized to provide rotational position sensing and encoding according to the present application. Furthermore, it should be appreciated that microprocessor 110 and/or circuitry 140 can share the signal/data processing tasks, methods, techniques, controls, and other functions described herein or either can perform all operations as desired for the particular application through execution of corresponding operating logic. Indeed, in other embodiments either is replaced by the other and/or other processors, controllers or the like are utilized in lieu of or in addition.

Another example of a further embodiment of the present application includes: rotating a body with at least a portion of a first sensing device fixed to the body to turn therewith in unison to provide one or more first device signals representative of body rotation; in response to the rotating of the body, turning at least a portion of a second sensing device with a mechanical turn ratio relative to the body to provide one or more second device signals representative of the body rotation; representing rotation of the portion of the first sensing device relative to the body with a virtual turn ratio greater than unity; and processing the one or more first device signals and the one or more second device signals as a function of the virtual turn ratio to provide an output signal representative of rotational position of the body over a desired angular range. In one nonlimiting form, this range spans more than 360°.

Still another example includes a steering system including a steering shaft, a first sensing device, and a second sensing device. The system also includes: means for rotating the shaft with at least a portion of the first sensing device fixed to the shaft to turn therewith in unison to provide one or more first device signals representative of shaft rotation, means for turning at least a portion of the second sensing device with a mechanical turn ratio relative to the shaft to provide one or more second device signals representative of such rotation, means for modeling rotation of the portion of the first sensing device relative to the shaft with a virtual turn ratio greater than unity, and means for processing the one or more first device signals and the one or more second device signals as a function of the virtual turn ratio to provide an output signal representative of rotational position of the shaft over a desired angular range. In one nonlimiting form, this range corresponds to multiple revolutions of the shaft.

Yet another example includes: rotating a body with at least a portion of a first sensing device coupled to the body to rotate in relation thereto with a first mechanical turn ratio and provide one or more first device signals representative of body rotation; turning at least a portion of a second sensing device with a second mechanical turn ratio relative to the body to provide one or more second device signals representative of the body rotation; and providing an angular output signal representative of rotational position of the body over a desired angular range which includes processing the first device signals and the second device signals in accordance with a virtual turn ratio of the portion of the first sensing device relative to the body. The virtual turn ratio is different than the first mechanical turn ratio and the second mechanical turn ratio. In one non-limiting form, the angular range extends more than 360°, and/or the virtual turn ratio is greater than the second mechanical turn ratio, the second mechanical turn ratio is greater than the first mechanical turn ratio, and the first mechanical turn ratio is unity.

A further example is directed to an apparatus including a first sensing device and a second sensing device to determine rotational position of a body. This apparatus includes: means for rotating the body with at least a portion of the first sensing device coupled to the body to rotate in relation thereto with a first mechanical turn ratio and provide one or more first device signals representative of body rotation, means for turning at least a portion of the second sensing device with a second mechanical turn ratio relative to the body to provide one or more second device signals representative of body rotation, and means for providing an angular output signal representative of rotational position of the body over a range of more than 360° which includes means for processing the first device signals and the second device signals in accordance with a virtual turn ratio of the portion of the first sensing device relative to the body, with the virtual turn ratio being different than the first mechanical turn ratio and the second mechanical turn ratio.

In another example, a rotational position sensing system includes a first sensing device and a second sensing device. A portion of the first device is fixed to a body, the rotation of which is to be detected and the second sensing device includes a portion mechanically coupled to the body to rotate with a mechanical turn ratio relative thereto. Also included is signal processing circuitry responsive to signals from the first sensing device and the second sensing device to provide an output representative of rotational position of the body over a desired angular range as a function of a virtual turn ratio of the portion of the first sensing device coupled to the body that is greater than unity.

In still another example, a method includes: rotating a first portion of a first sensing device relative to a second portion of the sensing device, with one of the first and second portions defining three or more sensing tracks. Determining a first plurality of bits from the tracks each of which corresponds to a respective signal from a different one of the tracks and each different value defined by the first bits being representative of a different rotational position; selecting one of the tracks from two or more of the tracks as a function of the first bits; quantifying magnitude of the respective signal with a second plurality of bits for the one of the tracks selected; and providing a first device rotational position value including the first bits and the second bits with the first bits being more numerically significant than the second bits.

A further example includes a first sensing device with: means for rotating a first portion of the first sensing device relative to a second portion of the first sensing device with one of the first and second portions defining three or more sensing tracks, means for determining a first plurality of bits from the tracks with each one of the first bits corresponding to a respective signal from a different one of the tracks and each different value defined by the first bits being representative of a different rotational position, means for selecting one of the tracks from two or more of the tracks as a function of the first bits, means for quantifying magnitude of the respective signal with a second plurality of bits for one of the tracks selected, and means for providing a first device rotational position value including the first bits and the second bits with the first bits being more numerically significant from the second bits.

Yet a further example includes: rotating a body with at least a portion of a first sensing device fixed to the body to turn in unison therewith; turning at least a portion of a second sensing device in relation to the rotating body; processing a plurality of signals from the first sensing device and the second sensing device to determine rotational position of the body over a desired angular range, which includes detecting one of the plurality of different discrete patterns of signals with at least one of the first sensing device and the second sensing device, in which the patterns each correspond to a different rotational position of the body and each are represented by a different value of a first set of bits; and quantifying magnitude of one of the signals corresponding to one of the first bits to provide a second set of bits numerically less significant than the first bits.

Still a further example includes: a first sensing device including a first portion and a second portion structured to rotate in relation to each other with at least one of the first portion and the second portion including three or more first device sensing tracks and processing circuitry coupled to the first sensing device to determine a first sequence of bits with each one of the first bits corresponding to a respective signal from a different one of the tracks and each different value of the first bits being representative of a different rotational position. The processing circuitry includes logic to select one track from among two or more of the tracks and quantify magnitude of the respective signal from the one track selected to provide a second sequence of bits and provide a rotational position output including the first bits and the second bits with the first bits being more numerically significant than the second bits.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A method, comprising:
rotating a body with at least a portion of a first sensing device fixed to the body to turn therewith in unison to provide one or more first device signals representative of body rotation;
turning at least a portion of a second sensing device with a mechanical turn ratio relative to the body to provide one or more second device signals representative of the body rotation;
representing rotation of the portion of the first sensing device relative to the body with a virtual turn ratio greater than unity; and
processing the one or more first device signals and the one or more second device signals as a function of the virtual turn ratio to provide an output signal representative of rotational position of the body over a desired angular range.

2. The method of claim 1, wherein the virtual turn ratio and the mechanical turn ratio are each greater than unity relative to the body and are each different from one another.

3. The method of claim 1, wherein the first sensing device includes a first device pickup fixed to the body and positioned opposite a first device face defining a plurality of sensing tracks, and further comprising:
determining a first plurality of bits from the tracks with the first device pickup, each one of the first bits corresponding to a respective signal from a different one of the tracks, each different value of the first bits being representative of a different rotational position;
selecting one of the tracks from two or more of the tracks as a function of the first bits; and
for the one of the tracks, quantifying magnitude of the respective signal with a second plurality of bits, the first bits being numerically more significant than the second bits.

4. The method of claim 3, wherein the body is in the form of a steering shaft, and further comprising:
turning a first gear in unison with the body;
rotating a second gear meshed with the first gear to turn with the mechanical turn ratio, the second sensing device including a second device pickup fixed to the second gear to turn therewith; and
providing the second device signals in correspondence to a pattern of concentric tracks defined by a second device face opposite the second device pickup.

5. The method of claim 1, wherein the first sensing device includes a first device face defining a plurality of sensing tracks, a geometric pattern of the sensing tracks repeats a number of times on the first device face equivalent to the virtual turn ratio.

6. The method of claim 5, wherein the turn ratio is four in correspondence to four instances of the geometric pattern, and which includes:
sensing capacitively coupled signals from each of the sensing tracks with the pickup; and
detecting multiple turns of a steering shaft based on the output signal.

7. A method, comprising:
rotating a body with at least a portion of a first sensing device coupled to the body to rotate in relation thereto with a first mechanical turn ratio and provide one or more first device signals representative of body rotation;
turning at least a portion of a second sensing device with a second mechanical turn ratio relative to the body to provide one or more second device signals representative of the body rotation; and
providing an angular output signal representative of rotational position of the body over a range of more than 360 degrees, which includes processing the first device signals and the second device signals in accordance with a virtual turn ratio of the portion of the first sensing device relative to the body, the virtual turn ratio being different than the first mechanical turn ratio and the second mechanical turn ratio.

8. The method of claim 7, wherein the first mechanical ratio of unity, the second mechanical turn ratio is greater than unity, and the virtual turn ratio is greater than the second mechanical turn ratio.

9. The method of claim 7, wherein the first sensing device includes a first device pickup fixed to the body and positioned opposite a first device face defining a plurality of sensing tracks, and further comprising:
determining a first plurality of bits from the tracks with the first device pickup, each one of the first bits corresponding to a respective signal from a different one of the tracks, each different value of the first bits being representative of a different rotational position;
selecting one of the tracks from two or more of the tracks as a function of the first bits; and
for the one of the tracks, quantifying magnitude of the respective signal with a second plurality of bits, the first bits being numerically more significant than the second bits.

10. The method of claim 9, wherein the body is in the form of a steering shaft, and further comprising:
turning a first gear in unison with the body;
rotating a second gear meshed with the first gear to turn with the mechanical turn ratio, the second sensing device including a second device pickup fixed to the second gear to turn therewith; and
providing the second device signals in correspondence to a pattern of concentric tracks defined by a second device face opposite the second device pickup.

11. The method of claim 7, wherein the first sensing device includes a first device face defining a plurality of sensing tracks, a geometric pattern of the sensing tracks repeats a number of times on the first device face equivalent to the virtual turn ratio.

12. The method of claim 11, wherein the turn ratio is four in correspondence to four instances of the geometric pattern, and which includes:
sensing capacitively coupled signals from each of the sensing tracks with the pickup; and
detecting multiple turns of a steering shaft based on the output signal.

13. An apparatus, comprising:
a rotatable body;
a first sensing device including a first portion fixed to the body to rotate therewith in unison and provide a plurality of first device signals;
a second sensing device including a second portion mechanically coupled to the body to rotate with a mechanical turn ratio relative to the body and provide a plurality of second device signals; and
signal processing circuitry responsive to the first device signals to represent rotation of the first portion relative to the body with a virtual turn ratio different than unity and the mechanical turn ratio, the signal processing circuitry including logic operable to provide an output representative of rotational position of the body over an angular range spanning more than 360 degrees as a function of the first device signals and the second device signals based on the virtual turn ratio.

14. The apparatus of claim 13, wherein the rotatable body is in the form of a steering shaft of a vehicle and further comprising a computer network coupled to the signal processing circuitry to receive the output.

15. The apparatus of claim 13, wherein the signal processing circuitry includes means for determining a first set of bits each from a different one of a number of sensing tracks and means for interpolating a second set of bits from magnitude of a selected one of the tracks.

16. The apparatus of claim 13, wherein the mechanical turn ratio is greater than unity and the virtual turn ratio is greater than the mechanical turn ratio.

17. The apparatus of claim 13, wherein:
the first sensing device includes a first device pickup fixed to the body and positioned opposite a first device face defining a plurality of first device sensing tracks; and
the second sensing device includes a second device pickup positioned opposite a second device face defining a plurality of second device sensing tracks.

18. The apparatus of claim 17, further comprising:
a first gear fixed to the body;
a second gear meshed with the first gear, the second device pickup being fixed to the second gear to turn therewith; and
a substrate defining the first device sensing tracks about a first rotational axis for the first gear and the second device sensing tracks about a second rotational axis for the second gear.

19. A method, comprising:
rotating a first portion of a first sensing device relative to a second portion of the first sensing device, one of the first portion and the second portion defining three or more sensing tracks;
determining a first plurality of bits from the tracks, each one of the first bits corresponding to a respective signal from a different one of the tracks, each different value defined by the first bits being representative of a different rotational position;
selecting one of the tracks from two or more of the tracks as a function of the first bits;
for the one of the tracks, quantifying magnitude of the respective signal with a second plurality of bits; and
providing a first device rotational position value including the first bits and the second bits with the first bits being more numerically significant than the second bits.

20. The method of claim 19, which includes:
rotating a body carrying one of the first portion and the second portion to turn therewith in unison;
modeling rotation of the one of the first portion and the second portion with a virtual turn ratio greater than unity.

21. The method of claim 19, which includes:
turning at least a portion of a second sensing device with a mechanical turn ratio relative to the body;
determining a second device rotational positional value with the second sensing device; and
providing an angular output signal representative of rotational position of the body over a range of more than 360 degrees as a function of the first device rotational position value and the second device rotational position value.

22. The method of claim 19, which includes:
rotating a steering shaft of a vehicle carrying one of the first portion and the second portion to turn therewith in unison;
modeling rotation of the one of the first portion and the second portion with a virtual turn ratio; and
turning at least a portion of a second sensing device with a mechanical turn ratio relative to the shaft, the mechanical turn ratio being greater than unity and the virtual turn ratio being greater than the mechanical turn ratio; and
providing an angular output signal representative of rotational position of the shaft over an angular range of more than 360 degrees as a function of the virtual turn ratio and the mechanical turn ratio.

23. The method of claim 19, wherein the first sensing device includes a first device face defining the sensing tracks and a geometric pattern of the sensing tracks repeats a number of times on the first device face and further comprising representing rotation of the first sensing device with a virtual turn ratio equal to the number of times the geometric pattern of the sensing tracks repeats on the first device face.

24. A method, comprising:
rotating a body with at least a portion of a first sensing device fixed to the body to turn in unison therewith;
turning at least a portion of a second sensing device in relation to the rotating of the body;
processing a plurality of signals from the first sensing device and the second sensing device to determine rotational position of the body over an angular range greater than 360 degrees, which includes:
detecting one of a plurality of different discrete patterns of signals with at least one of the first sensing device and the second sensing device, the patterns each corresponding to a different rotational position of the body and each being represented by a different value of a first set of bits; and
quantifying magnitude of one of the signals corresponding to one of the first bits to provide a second set of bits numerically less significant than the first bits.

25. The method of claim 24, wherein the turning occurs with a mechanical turn ratio greater than unity relative to the body.

26. The method of claim 25, which includes modeling rotation of the portion of the first sensing device with a virtual turn ratio greater than the mechanical turn ratio.

27. The method of claim 24, wherein:
the first sensing device includes a first device pickup fixed to the body and positioned opposite a first device face defining a plurality of first device sensing tracks; and
the second sensing device includes a second device pickup positioned opposite a second device face defining a plurality of second device sensing tracks.

28. The method of claim 27, wherein the body is in the form of a steering shaft for a vehicle and a geometric pattern of the first device sensing tracks repeats a number of times on the first device face and further comprising representing rotation of the first sensing device with a virtual turn ratio equal to the number of times the geometric pattern of the sensing tracks repeats on the first device face.

29. The method of claim 27, wherein each one of the first bits corresponds to a different one of the first device sensing tracks and the quantifying of the magnitude includes converting the one of the signals from an analog form to a digital form.

30. An apparatus, comprising:
a first sensing device including a first portion and a second portion structured to rotate in relation to each other, at least one of the first portion and the second portion including three or more first device sensing tracks; and
processing circuitry coupled to the first sensing device to determine a first sequence of bits, each one of the first bits corresponding to a respective signal from a different one of the tracks, each different value of the first bits being representative of a different rotational position, the processing circuitry including logic to select one track from among two or more of the tracks and quantify magnitude of the respective signal from the one track to provide a second sequence of bits and provide a rotational position output including the first bits and the second bits with the first bits being more numerically significant than the second bits.

31. The apparatus of claim 30, further comprising a steering shaft fixed to turn with one of the first portion and the second portion of the first sensing device in unison.

32. The apparatus of claim 31, wherein the processing circuitry includes means for representing rotation of the one of the first portion and the second portion with a virtual turn ratio greater than unity.

33. The apparatus of claim 31, further comprising a second sensing device and means for turning at least a portion of the second sensing device with a mechanical turn ratio greater than unity relative to the steering shaft.

34. The apparatus of claim 31, wherein the first sensing device includes a first device pickup fixed to the body and positioned opposite a first device face defining the first device sensing tracks; and further comprising a second sensing device including a second device pickup positioned opposite a second device face defining a plurality of second device sensing tracks.

35. The apparatus of claim 34, further comprising:
a rotatable body;
a first gear fixed in relation to the body and the first device pickup to turn therewith in unison;
a second gear meshed with the first gear, the second device pickup being fixed to the second gear to turn therewith; and
a substrate defining the first device sensing tracks about a first rotational axis for the first gear and the second device sensing tracks about a second rotational axis for the second gear.
